(19) United States
(12) Patent Application Publication
(10) Pub. No.: US 2025/0278250 A1
(43) Pub. Date: Sep. 4, 2025

(54) ELECTRONIC DEVICE FOR COMPILING AND METHODS THEREOF

(71) Applicants: CRYPTO LAB INC., Seoul (KR); UIF (UNIVERSITY INDUSTRY FOUNDATION), YONSEI UNIVERSITY, Seoul (KR)

(72) Inventors: Seonyoung Cheon, Seoul (KR); Yongwoo Lee, Seoul (KR); Dongkwan Kim, Seoul (KR); Ju Min Lee, Seoul (KR); Hanjun Kim, Seoul (KR); Junbum Shin, Suwon-si (KR); Taekyung Kim, Seoul (KR); Sunchul Jung, Seoul (KR); Sanghoon Park, Seoul (KR)

(21) Appl. No.: 18/942,995

(22) Filed: Nov. 11, 2024

(30) Foreign Application Priority Data
Nov. 10, 2023 (KR) 10-2023-0155708
Nov. 7, 2024 (KR) 10-2024-0156997

(51) Int. Cl. G06F 8/30; G06F 8/41; H04L 9/00

(52) U.S. Cl. CPC G06F 8/30; G06F 8/41; H04L 9/008

(57) ABSTRACT

Disclosed is an electronic apparatus. The electronic apparatus includes an interface, a memory in which a compiler is stored, and a processor. The processor is configured to based on a first type of program is input through the interface, convert the program into a second type of program for processing a homomorphic encrypted ciphertext using the compiler, and identify a time when a bootstrapping is required to expand a plaintext space of the homomorphic encrypted ciphertext in the conversion process, and generate a code for inserting a bootstrapping operation at the identified time.

### BACKGROUND

### 1. Field

The present disclosure relates to an electronic apparatus for performing compiling and a method thereof.

### 2. Description of Related Art

With the development of electronic technology, various types of electronic apparatuses have been developed and spread. These electronic apparatuses provide various functions by executing programs created in various languages.

In order for an electronic apparatus to provide functions according to an execution of a program, an operation of translating a program produced by a programmer into a language that the electronic apparatus may recognize is required. A program that performs this operation is called a compiler, and this operation is called compiling.

Meanwhile, as personal privacy becomes more important, the importance of technology for preventing data used in the electronic apparatus from being exposed to a third party is also increasing. To this end, various encryption technologies are being used. One of them is a homomorphic encryption technology.

Since the homomorphic encryption technology is a technology that may process encrypted data by operating encrypted data in an encrypted state as it is, it is possible to provide various services while maintaining security by using the homomorphic encryption technology.

Accordingly, the need for a method of compiling a program that operates in general plaintext into a program that uses homomorphic encrypted ciphertext has arisen. However, in the case of the homomorphic encrypted ciphertext, as a scale increases during the process of performing the operation on the homomorphic encrypted ciphertext several times, a bootstrapping is required to initialize the scale. However, there was a problem in that the conventional compiler may not easily process the bootstrapping operation.

### SUMMARY

The present disclosure provides an electronic apparatus using a compiler that automatically determines a bootstrapping time, and a compiling method thereof.

According to an aspect of the present disclosure, an electronic apparatus includes an interface, a memory in which a compiler is stored, and a processor, in which the processor is configured to based on a first type of program is input through the interface, convert the program into a second type of program for processing a homomorphic encrypted ciphertext using the compiler, identify a time when a bootstrapping is required to expand a plaintext space of the homomorphic encrypted ciphertext, in the conversion process, and generate a code for inserting a bootstrapping operation at the identified time.

According to another aspect of the present disclosure, a method of compiling includes receiving a first type of program, and executing a compiler and converting the program into a second type of program for processing a homomorphic encrypted ciphertext, in which the converting includes identifying a time when a bootstrapping is required to expand a plaintext space of the homomorphic encrypted ciphertext and generating a code for inserting a bootstrapping operation at the identified time.

According to various embodiments of the present disclosure, a bootstrapping operation may be automatically added during a compilation process, thereby enabling the development of an efficient homomorphic encryption program.

### BRIEF DESCRIPTION OF THE DRAWINGS

FIG. 1 is a block diagram illustrating a configuration of an electronic apparatus according to at least one embodiment of the disclosure;

FIG. 2 is a block diagram illustration a configuration of a program stored in a memory of an electronic apparatus of FIG. 1;

FIG. 3 is a diagram illustrating an example of an execution flow of an input program;

FIG. 4 is a diagram illustrating an example of a detailed configuration of a compiler;

FIG. 5 is a diagram for describing an example of a method of compiling using the compiler of FIG. 4; and

FIG. 6 is a flowchart for describing a compiling method according to at least one embodiment of the present disclosure.

### DETAILED DESCRIPTION

Encryption/decryption may be applied to an information (data) transmission process performed in the present disclosure if necessary, and all expressions describing the information (data) transmission process in the present disclosure and claims should be interpreted as including cases of encryption/decryption even if not separately stated.

In the present disclosure, expressions such as “transmission (delivery) from A to B” or “A receiving from B” include transmission (delivery) or reception with another medium included therebetween, and does not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B.

In addition, in the present disclosure, the term “include” has a meaning encompassing further including other components in addition to elements listed as included.

In this disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In addition, in the present disclosure, “value” is defined as a concept including a vector and a polynomial form as well as a scalar value.

Mathematical operations and calculations of each step of the present disclosure to be described below may be implemented as computer calculations by the known coding method and/or coding designed to suit the present disclosure in order to perform the corresponding operations or calculations.

Specific equations to be described below are illustratively described among possible alternatives, and the scope of the present disclosure should not be construed as being limited to equations mentioned in the present disclosure.

For convenience of description, in the present disclosure, a notation is defined as follows.

For convenience of description, in the present disclosure, a notation is defined as follows.
a←D: Select element a according to distribution D
s₁, s₂∈R: Each of s₁ and s₂ is an element belonging to set R
mod(q): Modular operation with element q
┌⋅┐: Round-off internal value

Hereinafter, various embodiments of the present disclosure will be described in detail with reference to the accompanying drawings.

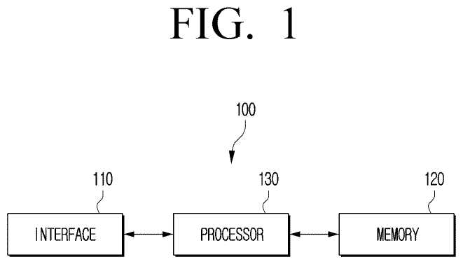

FIG. 1 is a block diagram illustrating a configuration of the electronic apparatus according to at least one embodiment of the disclosure. Referring to FIG. 1, the electronic apparatus 100 includes an interface 110, a memory 120, and a processor 130. The electronic apparatus 100 of FIG. 1 may be implemented as various types of devices such as a PC, a laptop PC, a smartphone, a tablet PC, a server device, and a kiosk.

The electronic apparatus 100 may be used to produce a program capable of processing a homomorphic encrypted ciphertext. The homomorphic encrypted ciphertext means an encrypted ciphertext encrypted with a homomorphic encryption technology that may perform an operation in an encrypted state and acquire the same result value as when the calculation is performed in a plaintext state when the calculation result is decrypted. In the present disclosure, the encrypted ciphertext means a homomorphic encrypted ciphertext.

The homomorphic encrypted ciphertext may be generated by encrypting a plaintext message using a public key. The homomorphic encrypted ciphertext may be generated in a form that satisfies the following properties when decrypted using a secret key.

$$Dec ( ct , sk ) = 〈 ct , sk 〉 = M + e ( mod q ) \qquad [ Equation 1 ]$$

Here, <, > denotes a usual inner product, ct denotes an encrypted message, sk denotes a secret key, M denotes a plaintext ciphertext, e denotes an encryption error value, and mod q denotes a modulus of an encrypted ciphertext. q should be selected to be greater larger than a result value M obtained by multiplying a scaling factor Δ by a message. When an absolute value of the error value e is sufficiently small compared to M, a decryption value M+e of the encrypted ciphertext is a value that may replace the original message with the same precision in significant figure calculation. Among the decrypted data, an error may be arranged on the least significant bit (LSB) side, and M may be arranged on the least significant bit side.

In the case of the homomorphic encrypted ciphertext, there are many advantages, such as preventing leakage of personal information, in that operations are possible in the encrypted ciphertext state. Therefore, program developers sometimes want to convert programs they want to use into programs capable of processing homomorphic encrypted ciphertext. The electronic apparatus 100 of FIG. 1 is used by a compiler that may perform such work.

Specifically, the interface 110 may receive a program to be converted. The interface 110 is configured to perform wired or wireless communication with various external devices.

The interface 110 may include at least one wireless communication module, at least one wired communication module, etc. Each communication module may be implemented in the form of at least one hardware chip. For example, the wireless communication module may include at least one of a Wi-Fi module, a Bluetooth module, an infrared communication module, or other communication modules. In addition, the interface 110 may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

For example, the wired communication module may include at least one of a local area network (LAN) module, an Ethernet module, a pair cable, a coaxial cable, an optical fiber cable, or an ultra wide-band (UWB) module. When an external terminal device is connected through various communication modules provided in the interface 110, the above-described program may be received from the external terminal device.

Meanwhile, the interface 110 may include various input/output interfaces that can be connected with various input means such as a keyboard, a joystick, a mouse, and a microphone, or a USB stick memory by a wired manner. A user may input a program using an input means connected through the input/output interface, or may transmit a program stored in an external memory to the electronic apparatus 100. The input/output interface may be variously implemented as a high definition multimedia interface (HDMI), a mobile high-definition link (MHL), a universal serial bus (USB), a USB C-type, a display port (DP), Thunderbolt, a video graphics array (VGA) port, an RGB port, a D-subminiature (D-SUB), a digital visual interface (DVI), etc.

Alternatively, the interface 110 may further include a touch screen, buttons provided on the body of the electronic apparatus 100, etc., and the user may input a first type of program by operating the touch screen or buttons.

Hereinafter, such a program may be referred to as an input program or the first type of program. The first type means those created in various programming languages (e.g., C language, C++, Java, etc.) used for program development, and therefore, may be referred to as a first language program.

Since these languages are basically developed on the premise of being used for plaintext data, it is difficult to create a program for processing homomorphic encrypted ciphertext. Specifically, in the case of the homomorphic encrypted ciphertext, it is common to use a polynomial operation, an NTT operation, a complex number operation, etc., and it often includes multiple loop operations, but the compilers of the existing programming languages do not support optimization methods, etc., for the above-described operations. In various embodiments of the present disclosure, unlike the conventional compiler, a compiler necessary for generation and operation processing of homomorphic encrypted ciphertext is used. This compiler may also be described as a homomorphic encryption compiler.

The memory 120 is a configuration that stores a homomorphic encryption compiler. The memory 120 may also store the first type of program input through the interface 110. In addition, the memory 120 may store various programs, data, instructions, etc., required for the operation of the electronic apparatus. In the present disclosure, the input may be used as meaning including all operations received through communication from an external device or input directly by a user through an input means.

The memory 120 may be implemented in a form of a memory embedded in the electronic apparatus 100 or a form of a memory detachable from the electronic apparatus 100, depending on a data storage purpose. For example, data for driving the electronic apparatus 100 may be stored in the memory embedded in the electronic apparatus 100, and data for expanding the functions of the electronic apparatus 100 may be stored in the memory that may be attached or detached to and from the electronic apparatus 100.

The memory 120 embedded in the electronic apparatus 100 may be implemented as at least one of, for example, a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, and a solid state drive (SSD)).

The processor 130 is connected to each component of the electronic apparatus 100 and is configured to control the overall operation of the electronic apparatus 100. The processor 130 may be implemented as a digital signal processor (DSP), a microprocessor, a graphics processing unit (GPU), an artificial intelligence (AI) processor, a neural processing unit (NPU), and a time controller (TCON) that process a digital image signal. However, the processor 130 is not limited thereto, and may include one or more of a central processing unit (CPU), a micro controller unit (MCU), a micro processing unit (MPU), a controller, an application processor (AP), a communication processor (CP), and an ARM processor, or may be defined by these terms. In addition, the processor 130 may be implemented by a system-on-chip (SoC) or a large scale integration (LSI) in which a processing algorithm is embedded, or may be implemented in the form of an application specific integrated circuit (ASIC) and a field programmable gate array (FPGA).

The processor 130 may perform operations according to various embodiments of the present disclosure based on data, programs, instructions, etc., stored in the memory 120.

In FIG. 1, the interface 110, the memory 120, and the processor 130 are each illustrated one by one, but each configuration may be implemented at least one or more. In addition, at least some of the memory 120 may be designed to be integrated with the processor 130.

For example, the processor 130 may execute a compiler to perform a compilation task of converting the first type of program into a second type of program. The second type of program may be a program that may process the homomorphic encrypted ciphertext and is translated into a machine language. Alternatively, it may be described as a program in a second language. In the present disclosure, it is assumed that there is one compiler, but the compiler may be implemented as multiple compilers. For example, multiple compilers, such as a first compiler that converts a first program language into a machine language and a second compiler that converts a second program language into a machine language, may be stored in the memory 120. The first compiler that optimizes the first program language and the second compiler that converts the optimized program language into the machine language may be stored in the memory 120 step by step.

As described above, the operation for the homomorphic encrypted ciphertext is composed of the polynomial operation, the NTT operation, the complex number operation, etc. The compiler supports variables that are often used in the homomorphic encryption, such as polynomials (or polynomials before NTT processing), polynomials in NTT form, and complex tensors. The compiler may perform an optimization operation to compile the first instruction included in the first language program into the machine language. The optimization operation may include various operations to improve the operation processing speed of the generated code.

For example, the processor 120 may generate a machine language loop by considering the size of the vector register during the above-described compilation operation. When the first instruction includes an instruction (e.g., an instruction for transforming a polynomial input value into an NTT) related to the polynomial NTT transformation, the processor 120 confirms a size of a vector register supported by the processor 120. The processor 120 may generate multiple machine language loops for NTT transformation based on the size of the vector register confirmed.

In addition, the processor 120 may set the above-described vector register size in various ways, confirm the performance according to each setting, determine an optimized size, and generate multiple machine language loops to have the determined optimized size.

In addition, the processor 120 may perform the optimization processing of the code by considering the sampling function.

In addition, the processor 120 may minimize heap allocation by considering the sampling function. For example, the result of the random sampling is usually used only once, and in this case, there is no need to allocate a new buffer to the heap.

In addition, the processor 120 may perform loop merging considering sampling.

Specifically, when the first instruction includes multiple loop operations with the same loop condition but different operation operations in each loop, the processor 120 may optimize the multiple loop operations to have the merged loop operation in which the loop conditions are the same but the operation operations within the loop operations are combined.

In addition, the processor 120 may perform optimization to reduce the number of times of the NTT operation. Specifically, the NTT operation has a time complexity of O (N log N) and requires more resources than other operations. Therefore, for high-efficiency or high-performance operation, it is necessary to perform the optimization to reduce the number of times of the NTT operation.

When the optimization operation for the instructions in the first type of program is performed in the above-described manner, the processor 120 may perform an operation of converting into the machine language based on the optimization operation. Meanwhile, the compiler according to the present disclosure is illustrated as performing both the optimization and machine language conversion, but when implemented, it may be implemented in a form of performing only the optimization operation and converting into the machine language using a conventional general compiler.

In the above, an example of a method of compiling into a program capable of processing the homomorphic encrypted ciphertext has been described, but it is not necessarily limited thereto, and the contents, method, and order of compiling may be changed.

Meanwhile, when performing the operation using the homomorphic encrypted ciphertext, a proportion of an approximate message in the encrypted ciphertext as an operation result acquired for each operation changes.

Specifically, when q is less than M in Equation 1 described above, since M+e (mod q) has a different value from M+e, the decryption becomes impossible. Therefore, the q value should always be kept greater than M. However, as the calculation progresses, the q value gradually decreases. Therefore, an operation of changing the q value so that it is always greater than M is required. This operation is called bootstrapping or bootstrapping. Alternatively, it may be called a plaintext space expansion operation. In this disclosure, it is generally referred to as bootstrapping.

The bootstrapping operation may be performed in various ways. For example, a device (e.g., a server device) that operates the homomorphic encrypted ciphertext may perform a bootstrapping operation by expanding the modulus of the encrypted ciphertext as a result of the operation, linearly transforming the homomorphic encrypted ciphertext with the expanded modulus into a polynomial form, performing an approximate modulus operation on the homomorphic encrypted ciphertext converted into the polynomial form using a polynomial equation set so that input values within a preset range approximate integer points, and then linearly transforming the operation result into the form of the homomorphic encrypted ciphertext. The bootstrapping operation is not limited thereto, and may be performed in a meta bootstrapping manner using an intermediate encrypted ciphertext, or in other ways.

When the bootstrapping is performed, the homomorphic encrypted ciphertext may be in a re-computable state. Therefore, in the second type of program capable of processing the homomorphic encrypted ciphertext, the bootstrapping operation should be inserted.

In the conventional homomorphic encryption compiler research, there was a problem that such a bootstrapping operation could not be automatically processed. Therefore, developers had the difficulty of having to find the times the bootstrapping is required in the operation process of the homomorphic encrypted ciphertext one by one and insert codes one by one to perform the bootstrapping operation at that time.

However, according to various embodiments of the present disclosure, since such work may be automatically processed, the development of the program for processing the homomorphic encrypted ciphertext may be performed much more easily and quickly.

Specifically, when the first type of program is input through the interface 110, the processor 130 executes the compiler stored in the memory 120 to perform compilation, thereby converting the first type of program into the second type of program capable of processing the homomorphic encrypted ciphertext. In the conversion process, the processor 130 identifies a time when the bootstrapping is required to expand the plaintext space of the homomorphic encrypted ciphertext during the execution of the second type of program. The processor 130 generates a code for inserting the bootstrapping operation at the identified time. The second type of program may be generated in a form including these codes.

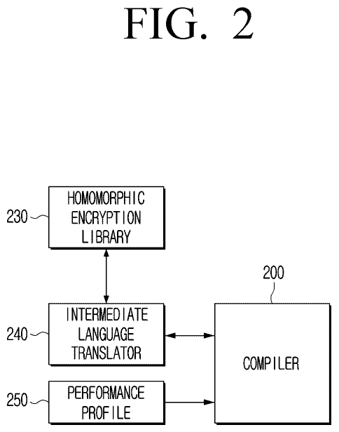

FIG. 2 is a block diagram illustrating an example of a program configuration of an electronic apparatus 100 for performing the above-described compilation. Referring to FIG. 2, various software modules and data, such as a compiler 200, a performance profile 250, an intermediate language translator 240, a homomorphic encryption library 230, etc., are stored in the memory 120.

The compiler 200 is a software module for performing the above-described compilation task. The processor 120 analyzes an execution flow of the first type of program based on the execution of the compiler 200.

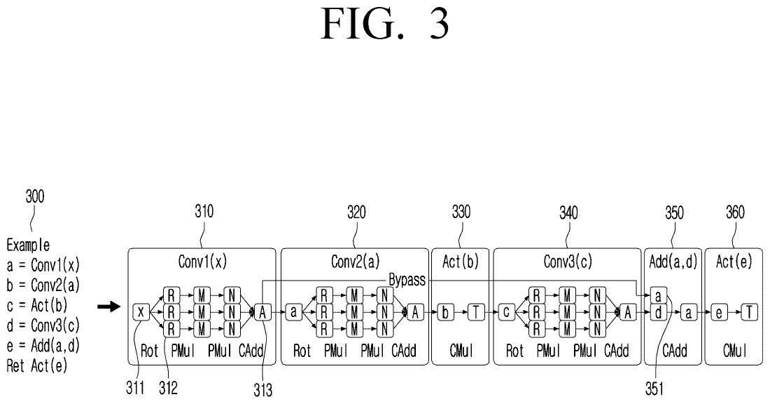

FIG. 3 is a diagram illustrating an example of an execution flow of an input program. FIG. 3 illustrates an example in which functions included in the input program 300 are each configured as a=Conv1(x), b=Conv2(a), c=Act(b), d=Conv3(e), e=Add(a, d), and Ret Act(e).

In this case, the execution flow is sequentially divided into six steps 310 to 360. In each step, a rotation operation Rot, a plaintext multiplication operation PMul, an encrypted ciphertext addition operation Cadd, an encrypted ciphertext multiplication operation CMul, etc., may be performed on a variable x. The variable x input to a first program point 311 of the first execution step 310 is stored as an R value in each of the three program points through the rotation operation, and then is provided to a last program point 313 through the plaintext multiplication operations PMul twice.

It may be seen that a value A of the last program point 313 is structured such that it bypasses the second to fourth execution steps 320 to 340 through a bypass path, is stored as a value in a first program point 351 of a fifth execution step 350, and is then added to a b value output through the normal path. The execution flow may also be called a graph. In addition, each program point in FIG. 3 may also be called a node.

The processor 130 may analyze this execution flow to identify the time when the bootstrapping is required, and then generate codes to perform the bootstrapping operation at that time.

The homomorphic encryption library 230 of FIG. 2 is a software module for supporting various schemes (CKKS, BFV, etc.), various parameter presets, various APIs, various operation functions, etc., related to the homomorphic encryption.

The intermediate language translator 240 is a software module for translating the code generated during the compilation process into the intermediate language. The compiling may be divided and processed in multi-phases such as a front end portion of the compiler and a back end portion of the compiler, and an intermediate code is used to connect these modules. The intermediate language may be a language for generating the intermediate code. For example, a low level virtual machine (LLVM) intermediate language may be used, but is not necessarily limited thereto.

The performance profile 250 is a module that includes performance measurement values of operations of the homomorphic encrypted ciphertext used in the second type of program. Before the compiling process, the performance of the homomorphic encrypted ciphertext operation provided by the library may be measured according to level and stored as the performance profile 250.

The data provided in the performance profile 250 may be information including a measurement value for the performance of the homomorphic encrypted ciphertext operation provided by the homomorphic encryption library 230. Specifically, the rotation operation Rot, the plaintext multiplication operation PMul, the encrypted ciphertext addition operation Cadd, and the encrypted ciphertext multiplication operation CMul provided by the homomorphic encryption library 230 are measured and stored for each level from the minimum level to the maximum level, and these measurement values are used by a performance analyzer 221 of the compiler 200.

The processor 130 may translate the code generated during the compiling process into the intermediate language using the intermediate language translator 240, and convert the translated code into the second type of program based on the homomorphic encryption library 230.

Meanwhile, when the bootstrapping operation is performed at every time when the bootstrapping is required, the performance of the second type of program may be degraded. Therefore, according to another embodiment of the present disclosure, for the bootstrapping candidates that require the bootstrapping, the performance thereof is analyzed to search for an optimal point, and then the optimized code may be generated.

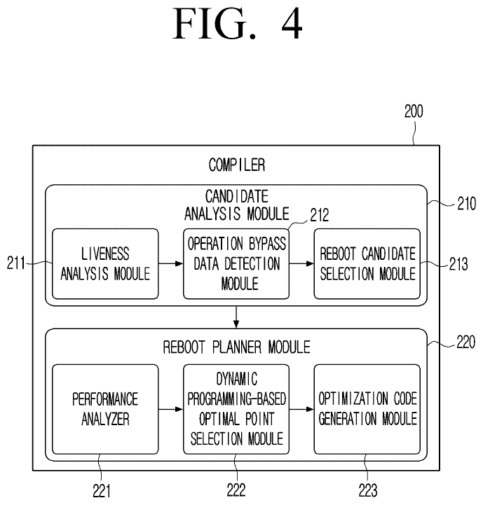

FIG. 4 illustrates an example of a detailed configuration of the compiler according to this embodiment. Referring to FIG. 4, the compiler 200 includes a candidate analysis module 210 and a bootstrapping planner module 220.

The candidate analysis module 210 is a software module for identifying the time when the bootstrapping is required for data processed by the first type of program, and determining the bootstrapping candidate based on the identified time. The bootstrapping candidate may be the time when the bootstrapping operation may be required.

The candidate analysis module 210 includes a liveness analysis module 211, an operation bypass data detection module 212, and a bootstrapping candidate selection module 213.

The liveness analysis module 211 is a software module for analyzing the number of live variables (variables used after the corresponding program point) at each program point in the execution flow of the input program. Bootstrapping all live variables at a specific point may exclude additional bootstrapping operations due to subsequent scale matches or level matches.

The operation bypass data detection module 212 is a software module for detecting data that bypasses without passing through intermediate points on the program point. Among the actual live variables of each program point on the execution flow, there may be variables that do not require the bootstrapping operation because the scale is not accumulated, i.e., the operation bypass data.

The operation bypass data detection module 212 considers a specific variable as operation bypass data if it is live until the point where the next bootstrapping operation is required, but the accumulated scale is below a certain level. The operation bypass data detection module 212 excludes such data from the bootstrapping candidates, leaving only the valid bootstrapping candidates.

The bootstrapping candidate selection module 213 is a software module that finds the minimum number of live variables required to execute the program among the valid bootstrapping candidates and selects the corresponding program points as bootstrapping candidates.

The bootstrapping planner module 220 determines a target for performing a bootstrapping operation among at least one bootstrapping candidate determined by the candidate analysis module 210.

For example, the bootstrapping planner module 220 may determine a bootstrapping location based on all the bootstrapping candidates.

As another example, the bootstrapping planner module 220 may determine the bootstrapping plan based on dynamic programming. When the bootstrapping operation is inserted at an inappropriate location, the bootstrapping is performed at an unnecessary time, resulting in scale overflow. Accordingly, the second type of program may output inaccurate results. On the other hand, when the bootstrapping operation is inserted by considering only the scale of the encrypted ciphertext, the unnecessary bootstrapping operation increases. For example, the bootstrapping operation may be unnecessary for data that is processed by the second type of program and for which subsequent operations are unnecessary. In particular, since the bootstrapping operation has the slowest operation speed among the homomorphic encryption operations, unnecessary bootstrapping operations may significantly deteriorate the overall performance of the program.

The performance of the homomorphic encryption operations is affected by the level of the encrypted ciphertext, and the location of the bootstrapping operation affects the level of other homomorphic encryption operations.

Therefore, the bootstrapping planner module 220 selects the most appropriate location among multiple bootstrapping candidates and generates a bootstrapping plan for performing the bootstrapping operation.

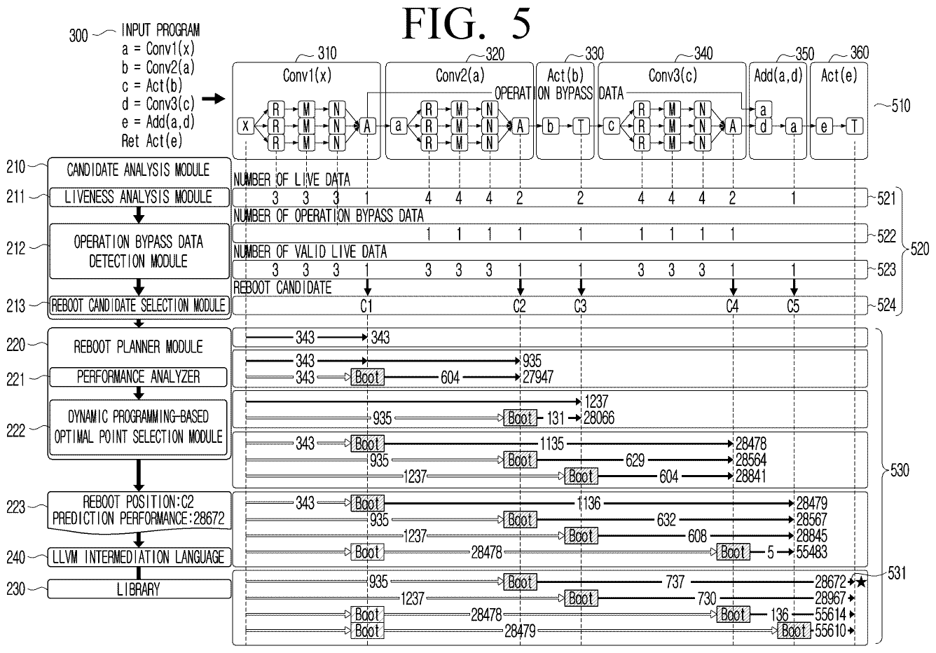

FIG. 4 illustrates a detailed configuration for generating the bootstrapping plan based on the dynamic programming. Specifically, the bootstrapping planner module 220 includes a performance analyzer 221, a dynamic programming-based optimal point selection module 222, and an optimization code generation module 223. The operations of each software module 221, 222, and 223 are specifically described based on the diagram of FIG. 5.

FIG. 5 is a diagram for describing an example of a method of compiling using the compiler of FIG. 4. FIG. 5 illustrates a process of converting the input program 300 described in FIG. 3 into the second type of program capable of processing the homomorphic encrypted ciphertext.

Specifically, when an input program 510 including functions such as a=Conv1(x), b=Conv2(a), c=Act(b), d=Conv3(e), e=Add(a, d), Ret Act(e) is input, the processor 130 analyzes an execution flow 510 corresponding to the input program 300.

As described above, the execution flow 510 is sequentially divided into six steps 310 to 360, each of which includes at least one program point.

The processor 130 identifies the bootstrapping candidate based on the execution of the candidate analysis module 210 (520).

Specifically, the processor 130 identifies the number of live data for each program point based on the execution of the liveness analysis module 211 (521). The number of live data may be counted by considering the bypass path of the execution flow 510 of FIG. 5.

The processor 130 identifies data following the bypass path of the execution flow 510, i.e., the operation bypass data, based on the execution of the operation bypass data detection module 212, and identifies the number of valid live data by considering the number of live data and the operation bypass data (522 and 523). Referring to FIG. 5, it may be seen that the operation bypass data is identified in the second to fourth steps 320, 330, and 340 of the execution flow 510.

The processor 130 selects the bootstrapping candidate based on the execution of the bootstrapping candidate selection module 213. In FIG. 5, it may be seen that a total of five bootstrapping candidates, such as C1, C2, C3, C4, and C5, are selected (S524).

The processor 130 may determine the optimal bootstrapping plan based on the execution of the bootstrapping planner module 220 (530). Specifically, the processor 130 may calculate the delay time when performing the bootstrapping for each bootstrapping candidate, and determine the bootstrapping plan based on the candidate with the minimum delay time.

For a detailed explanation in FIG. 5, it is assumed that the starting point of the execution flow 510 is S, the selected bootstrapping candidate points are C1, C2, C3, C4, and C5, and the end point of the program is R.

The performance analyzer 221 is a software module that randomly determines a point D among the selected candidates C1 to C5, and then finds the candidate points C1, C2, and C3 where the bootstrapping operation should be inserted before the point D in order to perform the bootstrapping operation at the point D, and analyzes the performance from the found candidate points to specific points (C1->D, C2->D, and C3->D).

The dynamic programming-based optimal point selection module 222 is a software module that identifies the bootstrapping plan with the lowest delay time to specific points (S->C1, S->C2, S->C3) based on a dynamic programming algorithm. When the processor 130 identifies a bootstrapping plan with the lowest delay time, it stores the bootstrapping plan in the memory 120 and finds the most optimal plan to the next candidate point (S->D) based on the bootstrapping plan. The processor 130 may reduce the compile time by reusing the stored value.

The optimization code generation module 223 is a software module that repeats the above-described process until the return point (S->R) and finds the bootstrapping plan with the lowest delay time until the point. The processor 130 generates a code by inserting the bootstrapping operation into a location corresponding to the bootstrapping plan identified based on the execution of the optimization code generation module 223.

Referring to FIG. 5, the expected delay times when the bootstrapping time is determined differently while sequentially designating an arbitrary point D for each of C1 to C5 are specifically illustrated. Referring to FIG. 5, it may be seen that a bootstrapping plan 531 that finally performs a bootstrapping at C2 has the smallest delay time 28672.

The processor 130 may translate the generated code into the intermediate language using the intermediate language translator 240, and convert the translated code into the second type of program based on the homomorphic encryption library 230. According to this, the processor 130 may perform the compiling into the second type of program that may perform the bootstrapping operation at the most optimized time.

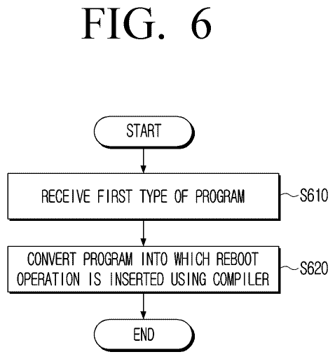

FIG. 6 is a flowchart for describing a compiling method according to at least one embodiment of the present disclosure.

Referring to FIG. 6, the electronic apparatus receives the first type of program (S610). As described above, the first type program may be the input program that is input to convert into the second type of program capable of processing the homomorphic encrypted ciphertext.

The electronic apparatus performs the compiling using the compiler described in various embodiments described above (S620).

During the compiling process, the electronic apparatus identifies the time when the bootstrapping is required to expand the plaintext space of the homomorphic encrypted ciphertext and generates a code for inserting the bootstrapping operation at the identified time. Since this compiling process has been specifically described in the various embodiments described above, a redundant description thereof will be omitted.

The compiling method of FIG. 6 may be performed by the electronic apparatus 100 having the configuration of FIG. 1 described above, but is not necessarily limited thereto, and may be performed by electronic apparatuses having various configurations.

When the compiling is performed in the same manner as FIG. 6, the second type of program capable of processing the homomorphic encrypted ciphertext may be secured. The electronic apparatus storing the second type of program may perform an operation suitable for the design purpose of the input program on the homomorphic encrypted ciphertext when the plurality of homomorphic encrypted ciphertexts are input.

In the above-described section, various embodiments have been individually described, but each embodiment does not necessarily have to be implemented alone, and may be implemented together by being partially or entirely combined with at least one other embodiment.

In addition, the program for performing the above-described compiling method may be distributed or used in a state stored in a non-transitory readable recording medium. The non-transitory computer-readable medium is not a medium that stores data for a while, such as a register, a cache, a memory, or the like, but means a medium that semi-permanently stores data and is readable by the device. Specific examples of the non-transitory computer-readable medium may include a compact disk (CD), a digital versatile disk (DVD), a hard disk, a Blu-ray disk, a USB, a memory card, a read only memory (ROM), and the like.

Although the embodiments of the disclosure have been illustrated and described hereinabove, the disclosure is not limited to the specific embodiments described above, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. An electronic apparatus, comprising:
an interface;
a memory in which a compiler is stored; and
a processor,
wherein the processor is configured to:
based on a first type of program is input through the interface, convert the program into a second type of program for processing a homomorphic encrypted ciphertext using the compiler, and
identify a time when a bootstrapping is required to expand a plaintext space of the homomorphic encrypted ciphertext in the conversion process, and
generate a code for inserting a bootstrapping operation at the identified time,

2. The electronic apparatus as claimed in claim 1,
wherein the processor is configured to:
based on an execution of the compiler,
identify a time when the bootstrapping is required for the data processed by the program by analyzing an execution flow of the first type of program,
determine at least one bootstrapping candidate based on the identified time, and
generate the code based on one of the at least one bootstrapping candidate.

3. The electronic apparatus as claimed in claim 2, wherein the processor is configured to:
based on the number of candidates are identified in plural, calculate a delay time when the bootstrapping is performed on each of the plurality of candidates and determine a bootstrapping plan based on a candidate with a minimum delay time, and
generate the code for automatically inserting the bootstrapping operation according to the determined bootstrapping plan.

4. The electronic apparatus as claimed in claim 3,
wherein the processor configured to:
translates the generated code into an low level virtual machine (LLVM) intermediate language, and converts the translated code into the second type of program based on a homomorphic encryption library.

5. A method of compiling an electronic apparatus, comprising:
receiving a first type of program; and
executing a compiler and converting the program into a second type of program for processing a homomorphic encrypted ciphertext,
wherein the converting includes identifying a time when a bootstrapping is required to expand a plaintext space of the homomorphic encrypted ciphertext and generating a code for inserting a bootstrapping operation at the identified time.

6. The method of compiling as claimed in claim 5,
wherein the generating of the code comprising:
analyzing the execution flow of the first type of program;
identifying a time when the bootstrapping is required for data processed by the program based on the execution flow;
determining at least one bootstrapping candidate based on the identified time; and
generating the code based on one of the at least one bootstrapping candidate.

7. The method of compiling as claimed in claim 6,
wherein the generating of the code based on one of the at least one bootstrapping candidate comprising:
based on the candidates are identified in plural, calculating each delay time when the bootstrapping is performed on each of the plurality of candidates;
determining a bootstrapping plan based on a candidate with a minimum delay time; and
generating the code for automatically inserting the bootstrapping operation according to the determined bootstrapping plan.

8. The method of compiling as claimed in claim 7,
wherein the converting further comprising:
translating the generated code into a low level virtual machine (LLVM) intermediate language; and
based on a homomorphic encryption library, converting the translated code into the second type of program.
